(19) United States
(12) Patent Application Publication
(10) Pub. No.: US 2025/0189669 A1
(43) Pub. Date: Jun. 12, 2025

(54) NEAR RANGE OBJECT DETECTION

(71) Applicant: Luminar Technologies, Inc., Orlando, FL (US)

(72) Inventors: Anders Grunnet-Jepsen, Oviedo, FL (US); John P. Engberg, JR., Palo Alto, CA (US); David L. Paulsen, Mountain View, CA (US)

(21) Appl. No.: 18/535,212

(22) Filed: Dec. 11, 2023

(51) Int. Cl. G01S 17/10; G01S 7/48; G01S 7/487; G01S 7/497

(52) U.S. Cl. CPC G01S 17/10; G01S 7/4802; G01S 7/487; G01S 2007/4975

(57) ABSTRACT

In the present application, a lidar system is disclosed. The system comprises a light source configured to emit an output beam comprising a plurality of light pulses through a window. The system comprises a receiver configured to detect a reference signal, the reference signal corresponding to one of the plurality of light pulses reflected from the window. The receiver is configured to detect a received signal, the received signal comprising a signal portion corresponding to one of the plurality of light pulses scattered by a target located at a distance. The system comprises a processor configured to determine the distance to the target using the received signal, including by being configured to subtract the reference signal from the received signal.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light towards a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOVL) and receiver field of view (FOVR) for a lidar system.

FIG. 5 illustrates an example unidirectional scan pattern that includes multiple pixels and multiple scan lines.

FIG. 6 illustrates a waveform 600 on a receiver showing two “returns,” one from the front window and one from an “object” or a “target.”

FIG. 7 is a flow chart illustrating an embodiment of a process 700 of a lidar system for detecting objects.

FIG. 8 illustrates an example module 800 for the Optical T0 reference subtraction techniques.

FIG. 9 illustrates an example process 900 for the Optical T0 reference subtraction techniques.

FIG. 10 illustrates an example received signal 1004 before the reference subtraction techniques are applied and the resulting output signal 1006 after the reference subtraction techniques are applied.

FIG. 11 illustrates examples of measuring various types of obstructions on the glass window of the lidar system.

FIG. 12 illustrates an example process 1200 for detecting and classifying a type of window blockage.

FIG. 13A illustrates a lidar system 1302 detecting a wall 1304 at two different points (A and B) on the surface.

FIG. 13B illustrates the received signals corresponding to the measurement at point A and the measurement at point B of wall 1304, respectively.

FIG. 14 illustrates an example received signal 1400 when two laser pulses are emitted consecutively.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In various embodiments, a lidar system comprises at least a light source and a scanner. The light source is configured to emit light, and the scanner is configured to scan the emitted light. For example, a light source such as a laser can emit light of a particular operating wavelength that is scanned by the scanner towards a particular scan region, such as an area in front of a vehicle and/or along the sides or behind the vehicle. The emitted light passes through a light sensor window before reaching any downrange objects. In some embodiments, the sensor window is used at least in part to protect the lidar system, for example, from environmental elements such as road debris and weather. In various embodiments, the lidar system includes multiple detectors, for example, as part of a receiver module. The detectors can utilize different types of technology to detect scattered light. For example, one or more of the detectors can utilize avalanche photodiodes (APDs), one or more single-photon avalanche diodes (SPADs), one or more PN photodiodes, or one or more PIN photodiodes, etc. In some embodiments, a first detector of the lidar system is configured to detect at least a portion of the emitted light scattered by a target located downrange from the system. For example, the positioning of the first detector may be optimized to detect objects that are a certain distance from the lidar system and/or the application environment to which the lidar system is mounted, such as an automobile. In some embodiments, the first detector is optimized to detect objects that are up to 50 meters, 200 meters, or another distance away from the lidar system. In some embodiments, a second detector of the lidar system is configured to detect at least a portion of the emitted light scattered by an internal reference target to provide reference range and pulse energy information that can be used in various compensation procedures. In various embodiments, the first and second detectors are different detectors and are configured to detect different scatter patterns. One or more processors of the lidar system can be configured to analyze detected information from the detectors.

A lidar system may operate in a vehicle and includes multiple “eyes,” each of which has its own field of regard, or an angular range over which the eye scans targets using pulses of light in accordance with a scan pattern. The fields of regard can combine along a certain dimension (e.g., horizontally) to define the overall field of regard of the lidar system. The lidar system then can use data received via both eyes to generate a point cloud or otherwise process the received data. In a two-eye configuration of the lidar system, the two eyes can be housed together and scan the respective fields of regard via a shared window or separate windows, or the eyes can be housed separately. In the latter case, an assembly referred to as a “sensor head” can include a scanner, a receiver, and an optical element such as a collimator or a laser diode to generate or convey a beam of light.

Depending on the implementation, each eye of a lidar system can include a separate scanner. For example, each eye can be equipped with a pivotable scan mirror to scan the field of regard vertically and another pivotable scan mirror to scan the field of regard horizontally. Each eye of the lidar system can include a partially shared scanner. For example, each eye can be equipped with a pivotable scan mirror to scan the field of regard vertically, and a shared polygon mirror can scan the corresponding fields of regard horizontally, using different reflective surfaces. Each eye of the lidar system can include a fully shared scanner. For example, a pivotable planar mirror can scan the fields of regard vertically by reflecting incident beams at different regions on the reflective surface, and a shared polygon mirror can scan the corresponding fields of regard horizontally, using different reflective surfaces.

Different hardware configurations allow the lidar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left). Further, according to one approach, two eyes of a lidar system are arranged so that the fields of regard of the eyes are adjacent and non-overlapping. For example, each field of regard can span approximately 60 degrees horizontally and 30 degrees vertically, so that the combined field of regard of the lidar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the lidar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the lidar system can use output beams with different wavelengths.

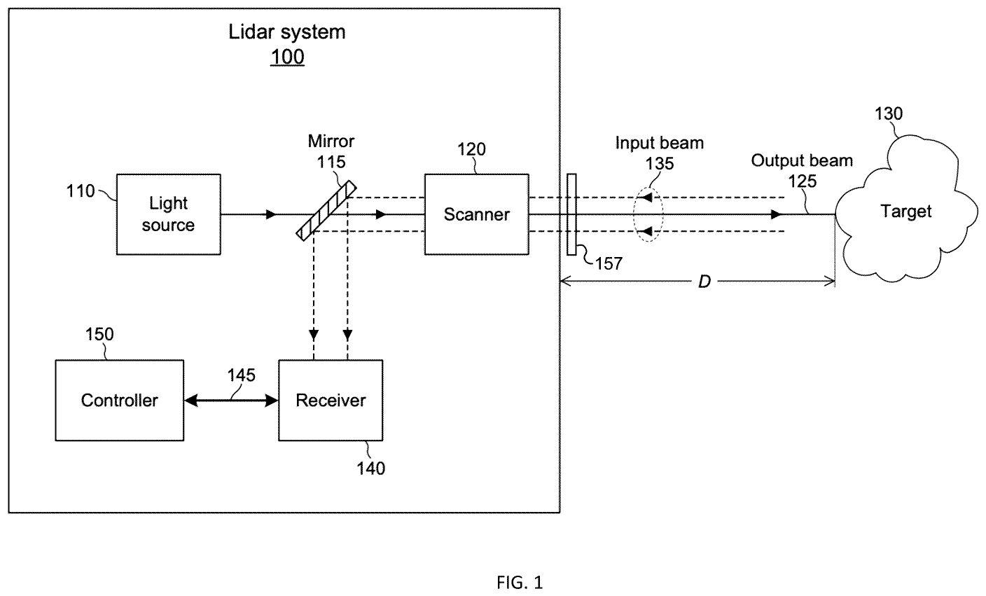

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, controller 150, or sensor window 157. The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through sensor window 157 and scanner 120 and is then reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10-1, 10-2, 10-3, 10-4, 10-5, 10-6, 10-7, 10-8, 10-9, 10-10, 10-11, or 10-12. As another example, if a pulse of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

In particular embodiments, output beam 125 may include or may be referred to as an optical signal, output optical signal, emitted optical signal, output light, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In various embodiments, lidar system 100 includes sensor window 157 through which the beams 125 and 135 pass. In some embodiments, one or more relatively high reflectivity regions (e.g., reflectivity of 1% to 5%) are located on sensor window 157 and can be utilized for calibration purposes (e.g., pulse energy and optical axis drift). The reflectivity regions can be of various sizes (e.g., small dots to large zones) depending on the type of calibration. Output beam 125 can be directed toward the reflectivity regions to perform calibration. In many scenarios, the reflectivity regions are not encountered while scanning a typical field of regard using output beam 125. Stated alternatively, the reflectivity regions do not interfere with normal operation of lidar system 100 when calibration using the reflectivity regions is not desired. When the reflectivity regions are utilized for calibration, the output beam of light source 110 may scatter or reflect at least a portion of light from the output beam 125. Some of the scattered or reflected light may return toward the lidar system 100. The light scattered or reflected can take a path similar to input beam 135. The light may pass through scanner 120 and be reflected by mirror 115 and directed to receiver 140.

In particular embodiments, receiver 140 may receive or detect photons from input beam 135 and produce one or more representative signals. For example, the receiver 140 may produce an output electrical signal 145 that is representative of the input beam 135, and the electrical signal 145 may be sent to controller 150. In particular embodiments, receiver 140 or controller 150 may include a processor, computing system (e.g., an ASIC or FPGA), or other suitable circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T represents a round-trip time of flight for an emitted pulse of light to travel from the lidar system 100 to the target 130 and back to the lidar system 100), then the distance D from the target 130 to the lidar system 100 may be expressed as D=c. T/2, where c is the speed of light (approximately 3.0×108 m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×108 m/s, and the speed of light in air (which has a refractive index of approximately 1.0003) is approximately 2.9970×108 m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 100 kHz to 10 MHz or a pulse period (e.g., a time between consecutive pulses) of approximately 100 ns to 10 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, 100 μJ, 1 mJ, or any other suitable pulse energy. As another example, output beam 125 may include pulses with a peak power of approximately 10 W, 100 W, 1 KW, 5 KW, 10 KW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed pulses which are amplified by the SOA, and the fiber-optic amplifier may further amplify the optical pulses.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output beam 125 may refer to an angular measure of an increase in beam size (e.g., a beam radius or beam diameter) as output beam 125 travels away from light source 110 or lidar system 100. In particular embodiments, output beam 125 may have a substantially circular cross section with a beam divergence characterized by a single divergence value. As an example, an output beam 125 with a circular cross section and a full-angle beam divergence of 2 mrad may have a beam diameter or spot size of approximately 20 cm at a distance of 100 m from lidar system 100. In particular embodiments, output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, or collimate the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scanning mirrors configured to pivot, rotate, oscillate, or move in an angular manner about one or more rotation axes. The output beam 125 may be reflected by a scanning mirror, and as the scanning mirror pivots or rotates, the reflected output beam 125 may be scanned in a corresponding angular manner. As an example, a scanning mirror may be configured to periodically pivot back and forth over a 30-degree range, which results in the output beam 125 scanning back and forth across a 60-degree range (e.g., a Θ-degree rotation by a scanning mirror results in a 2Θ-degree angular scan of output beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scanning mirror attached to a galvanometer scanner configured to pivot back and forth over a 1° to 30° angular range. As another example, a scanner 120 may include a scanning mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan the output beam 125 (which may include at least a portion of the light emitted by light source 110) across a field of regard of the lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scanning mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is substantially orthogonal to the first direction. As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scanning mirrors may be communicatively coupled to controller 150 which may control the scanning mirror(s) so as to guide the output beam 125 in a desired direction downrange or along a desired scan pattern. In particular embodiments, a scan pattern may refer to a pattern or path along which the output beam 125 is directed. As an example, scanner 120 may include two scanning mirrors configured to scan the output beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 130 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, silicon germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a received photocurrent (e.g., a current produced by an APD in response to a received optical signal) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse). The full waveform can also be captured via fast ADC (analog to digital conversion), after which digital signal processing can be used to locate and identify returns.

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and controller 150 may determine a time-of-flight value for an optical pulse based on timing information associated with when the pulse was emitted by light source 110 and when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (ROP) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. The operating range R_{OP} of a lidar system 100 may be related to the time τ between the emission of successive optical signals by the expression R_{OP}=c·τ/2. For a lidar system 100 with a 200-m operating range (R_{OP}=200 m), the time τ between successive pulses (which may be referred to as a pulse period, a pulse repetition interval (PRI), or a time period between pulses) is approximately 2·R_{OP}/c≅1.33 μs. The pulse period τ may also correspond to the time of flight for a pulse to travel to and from a target 130 located a distance R_{OP} from the lidar system 100. Additionally, the pulse period τ may be related to the pulse repetition frequency (PRF) by the expression τ=1/PRF. For example, a pulse period of 1.33 us corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×105 pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, scanner 120, and receiver 140 may be packaged together within a single housing, where a housing may refer to a box, case, or enclosure that includes sensor window 157 and holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825 1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

In particular embodiments, one or more lidar systems 100 may be integrated into a vehicle. As an example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

In particular embodiments, an optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. Alternatively, a lidar system 100 may be configured to operate as a frequency-modulated continuous-wave (FMCW) lidar system and may include a light source 110 that produces CW light or a frequency-modulated optical signal.

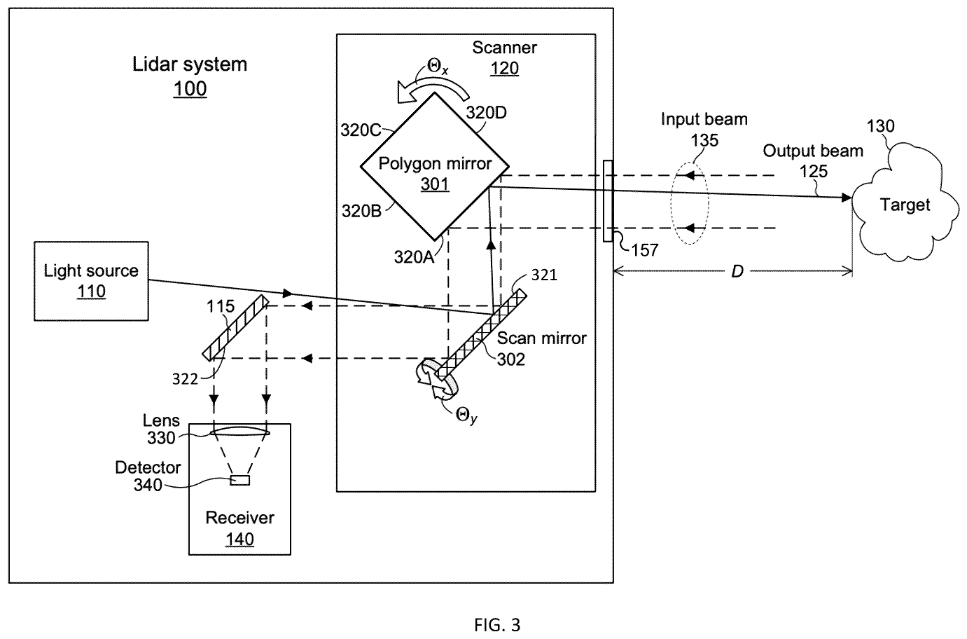

In particular embodiments, a lidar system 100 may be an FMCW lidar system where the emitted light from the light source 110 (e.g., output beam 125 in FIG. 1 or FIG. 3) includes frequency-modulated light. A pulsed lidar system is a type of lidar system 100 in which the light source 110 emits pulses of light, and the distance to a remote target 130 is determined based on the round-trip time-of-flight for a pulse of light to travel to the target 130 and back. Another type of lidar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the lidar system may correspond to a frequency difference between the received scattered light and the LO light. A larger frequency difference may correspond to a longer round-trip time and a greater distance to the target 130.

A light source 110 for a FMCW lidar system may include (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 1014 Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed using a frequency-analysis technique (e.g., a fast Fourier transform (FFT) technique) to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of an FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

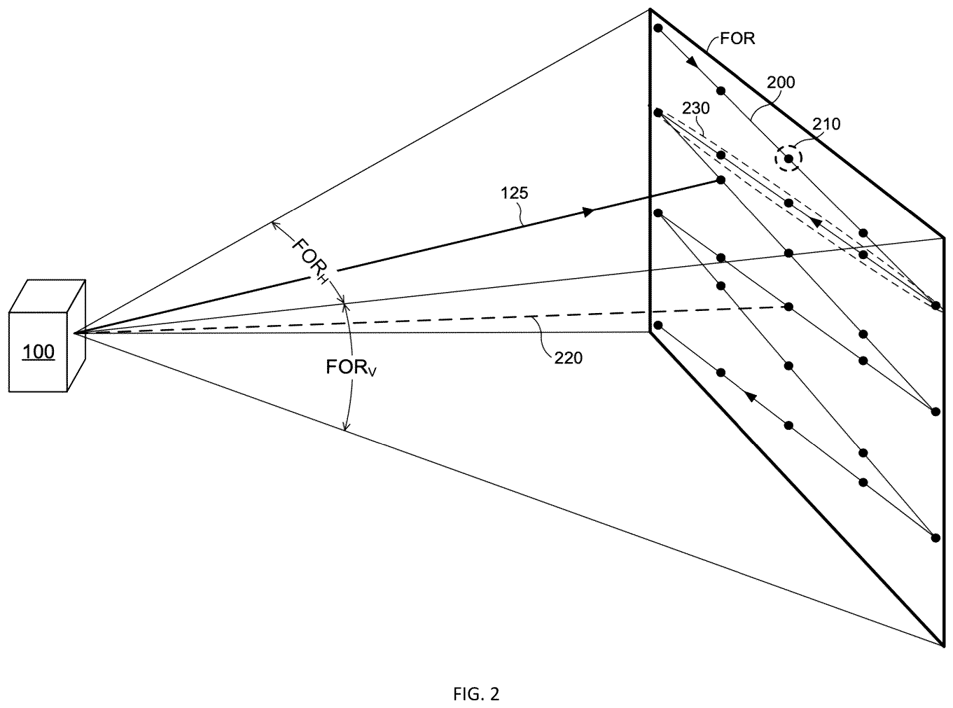

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a FOR of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 may correspond to the capture of a single frame or a single point cloud. In particular embodiments, a lidar system 100 may be configured to scan output optical beam 125 along one or more particular scan patterns 200. In particular embodiments, a scan pattern 200 may scan across any suitable field of regard (FOR) having any suitable horizontal FOR (FORH) and any suitable vertical FOR (FORV). For example, a scan pattern 200 may have a field of regard represented by angular dimensions (e.g., FORH×FORV) 40°×30°, 90°×40°, or 60°×15°. As another example, a scan pattern 200 may have a FORH greater than or equal to 10°, 25°, 30°, 40°, 60°, 90°, or 120°. As another example, a scan pattern 200 may have a FORV greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a nonzero horizontal angle or a nonzero inclination (e.g., a vertical angle of +10° or −10°). In FIG. 2, if the scan pattern 200 has a 60°×15° field of regard, then scan pattern 200 covers a +30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more laser pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a cycle of scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200. In particular embodiments, the number of pixels 210 along a horizontal direction may be referred to as a horizontal resolution of scan pattern 200, and the number of pixels 210 along a vertical direction may be referred to as a vertical resolution. As an example, scan pattern 200 may have a horizontal resolution of greater than or equal to 100 pixels 210 and a vertical resolution of greater than or equal to 4 pixels 210. As another example, scan pattern 200 may have a horizontal resolution of 100-2,000 pixels 210 and a vertical resolution of 4-400 pixels 210.

In particular embodiments, a pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated laser pulse was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scanning mirrors of scanner 120.

FIG. 3 illustrates an example lidar system 100 with an example rotating polygon mirror 301. In particular embodiments, a scanner 120 may include a polygon mirror 301 configured to scan output beam 125 along a particular direction. In the example of FIG. 3, scanner 120 includes two scanning mirrors: (1) a polygon mirror 301 that rotates along the Θₓ direction and (2) a scanning mirror 302 that oscillates back and forth along the Θ_{y} direction. The output beam 125 from light source 110, which passes alongside mirror 115, is reflected by reflecting surface 321 of scan mirror 302, is then reflected by a reflecting surface (e.g., surface 320A, 320B, 320C, or 320D) of polygon mirror 301, and then passes through sensor window 157. Scattered light from a target 130 returns to the lidar system 100 as input beam 135. The input beam 135 passes through sensor window 157 and then reflects from polygon mirror 301, scan mirror 302, and mirror 115, which directs input beam 135 through focusing lens 330 and to the detector 340 of receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%).

In particular embodiments, a polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or 9600 revolutions per minute (RPM)).

In particular embodiments, output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 321 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 321, and then the output beam 125 is directed to the polygon mirror 301, where it is reflected by reflective surface 320A.

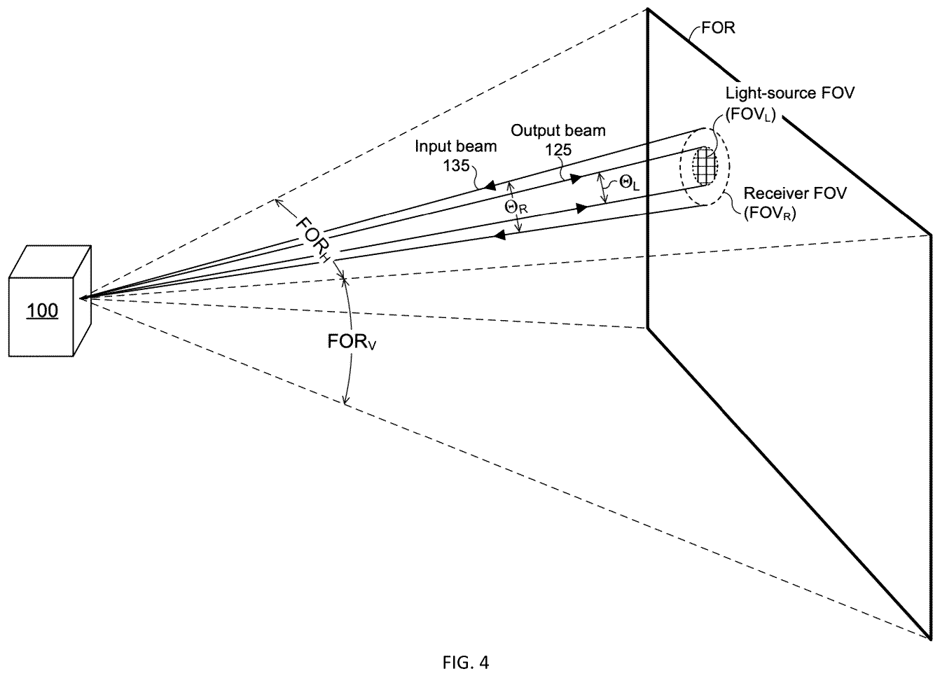

FIG. 4 illustrates an example light-source field of view (FOVL) and receiver field of view (FOVR) for a lidar system 100. A light source 110 of lidar system 100 may emit pulses of light as the FOVL and FOVR are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOVL is pointing at the time the pulse is emitted. The pulse of light may scatter off a target 130, and the receiver 140 may receive and detect a portion of the scattered light that is directed along or contained within the FOVR.

In particular embodiments, scanner 120 may be configured to scan both a light-source field of view and a receiver field of view across a field of regard of the lidar system 100. Multiple pulses of light may be emitted and detected as the scanner 120 scans the FOVL and FOVR across the field of regard of the lidar system 100 while tracing out a scan pattern 200. In particular embodiments, the light-source field of view and the receiver field of view may be scanned synchronously with respect to one another, so that as the FOVL is scanned across a scan pattern 200, the FOVR follows substantially the same path at the same scanning speed. Additionally, the FOVL and FOVR may maintain the same relative position to one another as they are scanned across the field of regard. As an example, the FOVL may be substantially overlapped with or centered inside the FOVR (as illustrated in FIG. 4), and this relative positioning between FOVL and FOVR may be maintained throughout a scan. As another example, the FOVR may lag behind the FOVL by a particular, fixed amount throughout a scan (e.g., the FOVR may be offset from the FOVL in a direction opposite the scan direction).

In particular embodiments, the FOVL may have an angular size or extent ΘL that is substantially the same as or that corresponds to the divergence of the output beam 125, and the FOVR may have an angular size or extent ΘR that corresponds to an angle over which the receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOVL may have any suitable angular extent ΘL, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOVR may have any suitable angular extent ΘR, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, Θ_{L} and Θ_{R} may both be approximately equal to 1 mrad, 2 mrad, or 4 mrad. In particular embodiments, the receiver field of view may be larger than the light-source field of view, or the light-source field of view may be larger than the receiver field of view. As an example, Θ_{L} may be approximately equal to 3 mrad, and Θ_{R} may be approximately equal to 4 mrad. As another example, Θ_{R} may be approximately L times larger than Θ_{L}, where L is any suitable factor, such as for example, 1.1, 1.2, 1.5, 2, 3, 5, or 10.

In particular embodiments, a pixel 210 may represent or may correspond to a light-source field of view or a receiver field of view. As the output beam 125 propagates from the light source 110, the diameter of the output beam 125 (as well as the size of the corresponding pixel 210) may increase according to the beam divergence Θ_{L}. As an example, if the output beam 125 has a Θ_{L} of 2 mrad, then at a distance of 100 m from the lidar system 100, the output beam 125 may have a size or diameter of approximately 20 cm, and a corresponding pixel 210 may also have a corresponding size or diameter of approximately 20 cm. At a distance of 200 m from the lidar system 100, the output beam 125 and the corresponding pixel 210 may each have a diameter of approximately 40 cm.

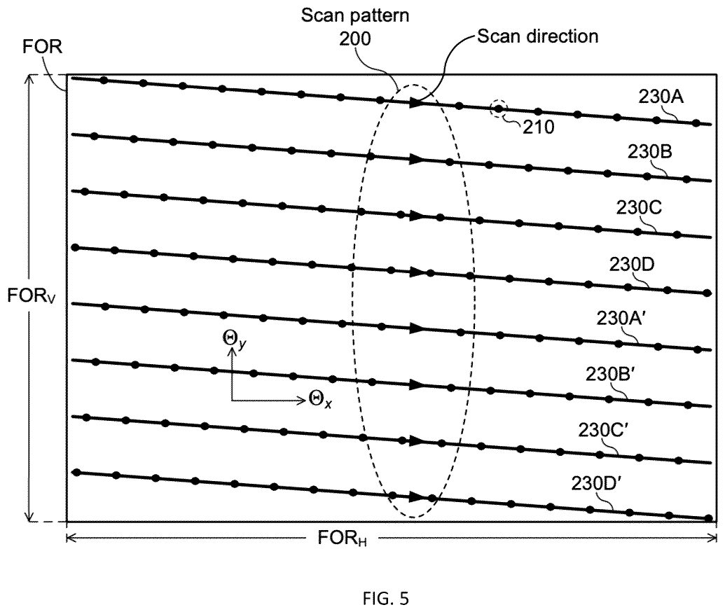

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

Long-range commercially available automotive lidars today excel at sensing objects in three dimensional (3D) space, with x, y, and z axes, up to ranges exceeding 300 meters (m), but most lidars tend to suffer from having a blind region for objects within 0.5 m to 1.5 m. While the far range tends to be limited by laser power and sensitivity of the receiver, the short range is instead impacted by minimum object separation distance.

The main challenge in achieving short range is that a typical automotive lidar has a front glass window that partially reflects some of the emitted light. When a light pulse is emitted, it passes through the front glass window to reach any objects downrange from the lidar system. But when the light pulse passes through the glass window, it may also cause scattered or reflected light from the glass window to return back into the system, which is detectable by the detector. Traditional lidar systems may send out a pulse of light and either disable the detector or ignore the detector signal until the pulse has scattered or reflected from the window. As a result, these lidar systems may detect downrange objects further away but are essentially blind for a period of time or a short distance from the system. In other words, this tends to blind the lidar for a short amount of time, and any other objects that appear within ˜1.5 m can be very difficult to disambiguate from the returns from the front window. For example, a normal direct detection lidar may use a short laser pulse with a duration of 2-10 nanoseconds (ns), and the receiver usually has a bandwidth of about 100 megahertz (MHz), which means the received impulse response is 7-10 ns. Converting this width to a distance travelled at ˜15 cm/ns, the pulse is ˜1 to 1.5 m wide.

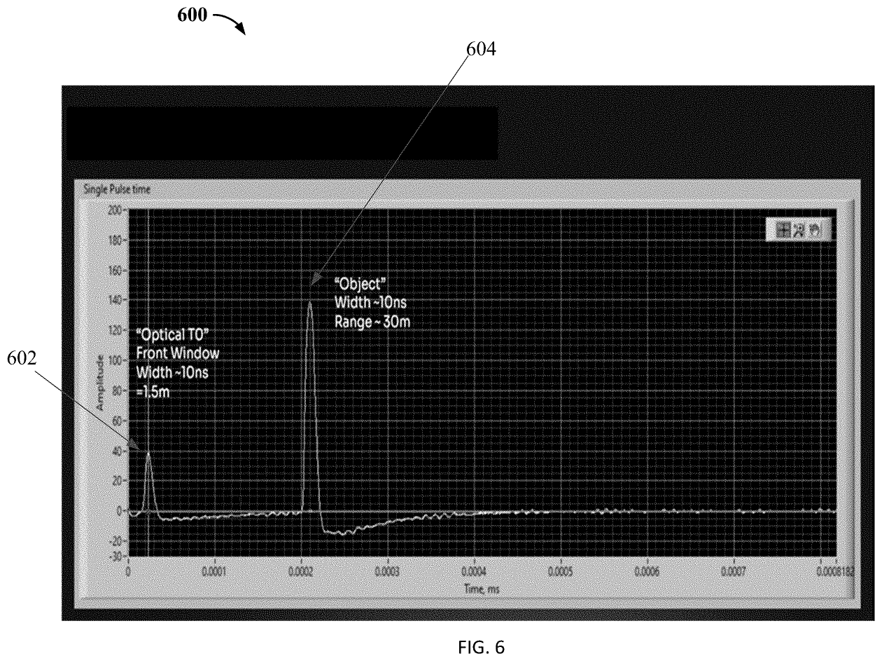

FIG. 6 illustrates a waveform 600 on a receiver showing two “returns,” one from the front window and one from an “object” or a “target.” Return 602 (also referred to as Optical T0) corresponds to an emitted laser pulse that hits the front window and then returns to the receiver. The width is ˜10 ns and the distance is 1.5 m. Return 604 (also referred to as Object or Object Return) corresponds to the emitted laser pulse that hits an object and then scatters off the object and returns to the receiver. The width is ˜10 ns, and the range is about 30 m. Since the object and Optical T0 are separated far enough apart, the two returns do not overlap and therefore can be distinguished from each other. However, as the object moves closer to the system and eventually reaches the glass window, the two returns will merge and make it difficult to distinguish the two and to extract the proper range. In other words, the system may not be able to detect whether there is an object in front of the window.

For systems that detect the arrival time of returns using fast comparators (threshold triggers) with time-to-digital conversion (TDC) circuitry, the challenge of separating the Optical T0 from the Object Return is especially difficult as TDC systems tend to have fewer samples on the returns, leading to a poorer resolution or “pulse reconstruction” and more difficulty in pulse separation. Systems based on fast ADCs (analog-to-digital converters) extract the full waveform by sampling many more points over time. However, even ADC systems may struggle to reduce the minimum operating distance to below 0.5 m as the two return pulses merge into one and become almost indistinguishable. While it is possible to develop techniques that improve on separating merged pulses, such as Gaussian decomposition or deconvolution, these techniques tend to be fairly unreliable and computationally intensive. In addition, these techniques may only reduce the minimum distance from 1.5 m to 0.5 m.

In the present application, improved techniques for a lidar system are used to accurately sense objects as close as zero meters. A reference subtraction or background removal technique is performed. A reference scan is obtained with no objects in front of the window. The stored reference scan provides a reference signal corresponding to Optical T0. To detect any objects, the reference scan is subtracted from the received signal in order to remove Optical T0, thereby enabling the detection of blockages on the window or nearby objects that are very close to the glass window.

The improved techniques have many benefits. The minimum ranging is reduced to 0 m. Per-ray window obstructions may be measured and characterized with the same ranging receiver, not requiring new detectors. The techniques are also useful as safety features of the lidar system. For example, if a person approaches the lidar system and is within a meter from the system, the system may be alerted to turn the laser off or reduce the laser power to avoid causing damage to the person's eyeballs. Lidar blockage is an abnormal condition of lidar systems when unwanted objects are attached to the glass window and block the light pulses and their return signals. Blockage detection is used to detect blockages and their sizes and locations. The improved techniques may be used to detect obstacles even directly on the front surface of the window on a per-ray basis, with a granularity that allows the system to accurately classify the obstruction type and the exact lidar performance degradation.

In the present application, a lidar system is disclosed. The system comprises a light source configured to emit an output beam comprising a plurality of light pulses through a window. The system comprises a receiver configured to detect a reference signal, the reference signal corresponding to one of the plurality of light pulses reflected from the window. The receiver is configured to detect a received signal, the received signal comprising a signal portion corresponding to one of the plurality of light pulses scattered by a target located at a distance from the system. The system comprises a processor configured to determine the distance from the system to the target using the received signal, including by being configured to subtract the reference signal from the received signal.

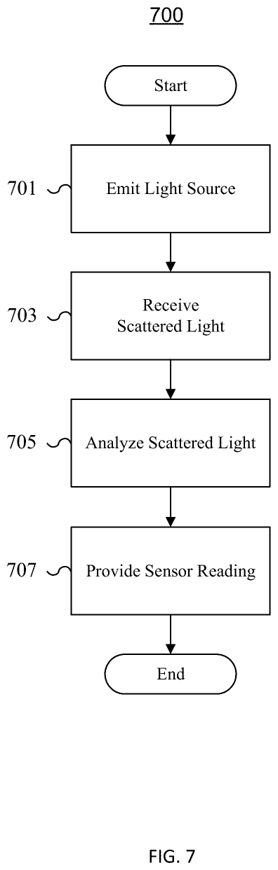

FIG. 7 is a flow chart illustrating an embodiment of a process 700 of a lidar system for detecting objects. Using the process of FIG. 7, a lidar system can detect different objects, including downrange objects, blockages on the sensor window, or nearby objects that are very close to the sensor window of the lidar system. For example, a vehicle equipped with the disclosed lidar system can detect other vehicles, pedestrians, lane markers, and street signs, etc. that are downrange from the vehicle, as well as blockages on the window, or nearby objects that are very close to the sensor window of the lidar system, such as a person, an animal, or an insect that is adjacent to the sensor window (e.g., within a meter from the system). Depending on the orientation and number of lidar systems installed on the vehicle, different fields of regard can be scanned to determine the corresponding environment surrounding the vehicle. Vehicle safety features as well as autonomous driving features can be implemented using the captured environmental data. In various embodiments, using the process of FIG. 7 with the disclosed lidar system, a single process can be performed for detecting objects that are located at different distances from the system. For example, the lidar system can be configured with a sensor window to protect the internal components of the lidar system and from which emitted output beams pass through to reach downrange objects. When the emitted beam hits an object, at least a portion of the scattered and/or reflected light can be captured by the lidar system as an input beam. In some scenarios, a return (i.e., Optical T0) corresponding to an emitted laser pulse that hits the front window and then returns to the receiver may impact the operation of the lidar system. This Optical T0 return can impact the ability of the lidar system to accurately detect objects in front of or on the window. As part of the process of FIG. 7, a reference subtraction or background removal technique is performed to detect objects in front of or on the window. A reference scan is obtained with no objects in front of the window. The stored reference scan provides a reference signal corresponding to Optical T0. To detect any objects, the reference scan is subtracted from the received signal in order to remove Optical T0, thereby enabling the detection of blockages on the window or nearby objects that are very close to the glass window. In some embodiments, the lidar system performing the process of FIG. 7 is lidar system 100 of FIGS. 1-4.

At 701, one or more beams of light are emitted. The light source is configured to emit an output beam comprising a plurality of light pulses that is scanned across any downrange objects through a window. For example, an output light beam is emitted from the lidar system that passes through a sensor window. The sensor window can act as a protective barrier for the lidar system while still allowing light to pass in both directions. In some embodiments, the lidar system emits multiple output beams, each potentially scanning a different field of regard. The output beam can reach downrange objects and can be scattered and/or reflected by the downrange objects.

At 703, scattered light is received. A receiver is configured to detect a received signal, the received signal comprising a signal portion corresponding to one of the plurality of light pulses scattered by a target located at a distance from the system. For example, light scattered and/or reflected by an object is received at the lidar sensor. The corresponding object can be a downrange object, a blockage on the sensor window, or a nearby object that is very close to the sensor window of the lidar system. In some embodiments, the transmit and receive axes of the emitted light and received light are offset, for example, by a parallax distance configured for the lidar system.

At 705, the received scattered light is analyzed. For example, the received scattered light is directed to a receiver component of the lidar system where sensor data can be captured and analyzed. In some embodiments, the receiver component includes a receive lens for focusing the received scattered light onto a readout integrated circuit (ROIC) of the receiver where detector site locations of the detector plane are located. The detector site locations can be used to detect scatter patterns associated with the received scattered light. In various embodiments, different detector site locations are utilized to detect light scattered from different objects, including downrange objects, blockages on the sensor window, or nearby objects very close to the window. In some embodiments, different detector site locations are utilized to differentiate light scattered from different emitted output beams. Using detectors positioned at the detector site locations, sensor data can be captured and analyzed for sensor readings. In some embodiments, the analysis is performed at least in part by the readout integrated circuit (ROIC) and/or processor of the receiver and/or a controller of the lidar system. The processing can include determining an output signal corresponding to the detected scatter pattern. In some embodiments, the output signal is a sensor reading that corresponds to a measurement of the detected scattered light, such as an intensity reading or another measured sensor reading.

At 707, a sensor reading is provided. For example, one or more sensor readings are provided in response to the analysis of the received scattered light performed at 705. The sensor reading can be an intensity reading and/or another measurement or measurements. In some embodiments, the sensor reading includes location and/or distance data. For example, sensor readings can correspond to a point cloud based on objects detected in the fields of regard scanned by the lidar system.

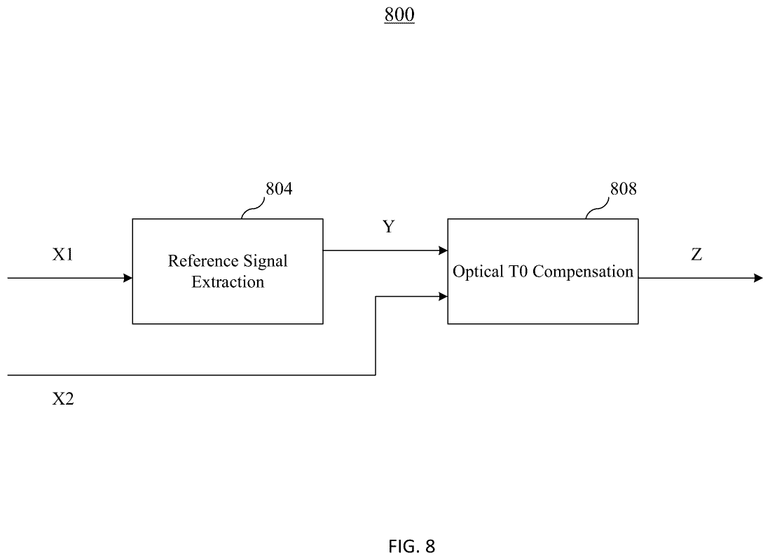

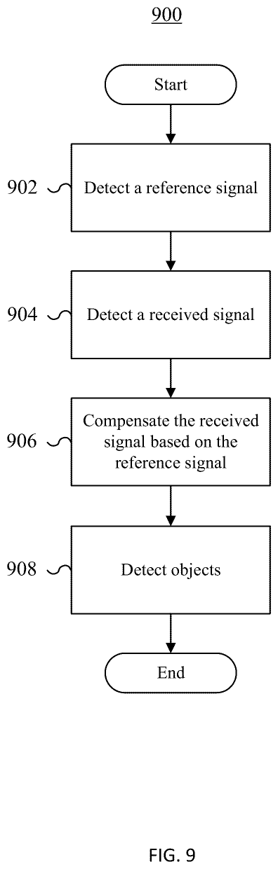

FIG. 8 illustrates an example module 800 for the Optical T0 reference subtraction techniques. FIG. 9 illustrates an example process 900 for the Optical T0 reference subtraction techniques. In some embodiments, module 800 and process 900 may be implemented or performed by receiver 140 and controller 150 of lidar system 100 of FIGS. 1-4. In some embodiments, module 800 of FIG. 8 may be used by process 900 of FIG. 9 to perform as least a part of the process of FIG. 7. For example, in some embodiments, each of modules 804 and 808 may be used by process 900 to perform at least a part of step 705 and/or step 707 of FIG. 7.

At step 902, a reference signal is detected by the receiver, wherein the reference signal corresponds to one of the plurality of light pulses reflected from the window. The input of reference signal extraction module 804, denoted as X1, may include the detected signals from the lidar returns corresponding to the scattered or reflected light from the glass window during a reference signal extraction phase. The reference signal extraction phase may be triggered by a system initialization. The reference signal extraction phase may also be a phase that is triggered and repeated periodically over time. For example, when the system has determined that no blockages are currently detected on the window or no objects are currently downrange from the system, the lidar system may repeat the reference signal extraction phase to dynamically update and recalibrate the reference signal when drifting of the reference signal due to drifts in temperature or other factors may occur. For example, the reference signal extraction phase may be triggered after a certain time limit has passed or when a certain temperature threshold has been reached. If an object is detected during a reference signal extraction phase, the reference signal extraction phase should be disabled. The reference signal may be a signal that is representative of the lidar returns scattered or reflected from the glass window of the system. Any central tendency statistical measures may be used to determine the reference signal, such as using a median of the signals collected during the reference signal extraction phases.

Signal X1 may be the voltage signals from receiver 140. Reference signal extraction module 804 samples and/or processes the input X1 and determines the Optical T0 reference signal Y, which is a reference scan with no objects in front of a clean window. The stored reference scan provides a reference signal corresponding to Optical T0. For example, the Optical T0 reference signal Y may be computed based on sensor readings that correspond to measurements of the detected scattered light obtained at step 705 of FIG. 7. Signal processing techniques may be used to extract the Optical T0 reference signal Y from the lidar returns scattered or reflected from the glass window of the system.

At step 904, a received signal is detected by the receiver, wherein the received signal comprises a signal portion corresponding to one of the plurality of light pulses scattered by a target located at a distance from the system. One of the inputs of Optical T0 compensation module 808 is denoted as X2, which includes the detected signals from the lidar returns corresponding to the scattered or reflected light from any objects that are either on the glass window or downrange from the system during an object detection phase. The object detection phase is a phase other than the reference signal extraction phases. For example, during the object detection phase, a vehicle equipped with the lidar system can detect other vehicles, pedestrians, lane markers, and street signs, etc. that are downrange from the vehicle, as well as blockages on the window, or nearby objects that are very close to the sensor window of the lidar system, such as a person, an animal, or an insect that is adjacent to the sensor window (e.g., within a meter from the system).

At step 906, the received signal is compensated based on the reference signal. In some embodiments, the reference signal is subtracted from the received signal. Optical T0 compensation module 808 receives the Optical T0 reference signal Y from reference signal extraction module 804 as an input. Optical T0 compensation module 808 compensates the noise and distortion in X2 that are caused by Optical T0 based on the Optical T0 reference signal Y from reference signal extraction module 804 and produces an output signal Z. Optical T0 reference signal Y is subtracted from X2 to produce output signal Z.

At step 908, objects are detected. The distances of the detected objects from the system are determined. The output signal Z from Optical T0 compensation module 808 is used to accurately detect any objects, including blockages on the window or nearby objects that are very close to the glass window.

At both step 902 and step 904 of process 900, sampling is performed to extract the full waveform of the returns. For example, ADCs may be used to capture the full waveform of the returns, and such a lidar system is referred to as a full waveform lidar system. A full waveform lidar system samples the return signals at a rate of between 1 Giga-samples per second (GSPS) to 4 GSPS in order to get ranging precision of 2 to 0.5 cm, for example. In some embodiments, the sampling rate is 1.25 Gigabit per second (Gbps) with 10-bit ADCs. The receiver bandwidth is ˜100 MHz, which means the received impulse response is 7-10 ns.

In some embodiments, the Optical T0 reference signal Y is an extracted portion of the full captured waveform with a filtering window around the peak of the Optical T0 return pulse. If a full captured waveform is used as the Optical T0 reference signal Y, then noise may be introduced into output signal Z when the noisy Optical T0 reference signal Y is subtracted from signal X2.

In some embodiments, the width of the extracted portion may be determined based on the width of the Optical T0 return. In some embodiments, the filtering window width may be the width of the Optical T0 return pulse multiplied by a scale factor. For example, the filtering window width is the pulse width plus 50% or double the pulse width. For example, since the width of the Optical T0 return (see e.g., return 602 in FIG. 6) is ˜10 ns, the Optical T0 reference signal Y may be an extracted portion of the full captured waveform that is ±10 ns around the Optical T0 return peak. The received signal during the object detection phase (i.e., at step 906) is then compensated based on this Optical T0 reference signal Y by subtracting the reference signal Y from the received signal, such that the effect of Optical T0 is removed.

The Optical T0 return peak location may vary over time as there may be electrical jitter or slight changes in the Optical T0 location across the Field-of-View of the sensor. In response to detecting a jitter in the received signal, adjustments may be made dynamically by measuring the location of the Optical T0 in the received signal, and then temporally shifting (with sub-pixel resolution) the stored Optical T0 reference waveform to align with the location of the Optical T0 before subtracting the reference waveform from the received signal. This shifting of the peak location of Optical T0 return is referred to as the sub-pixel shift operation. In some embodiments, the stored Optical T0 reference waveform and the Optical T0 return in the received signal are aligned based on their respective rising edges. In some embodiments, the sub-pixel shift uses the rising edge of the first peak of the received signal as a timing reference.

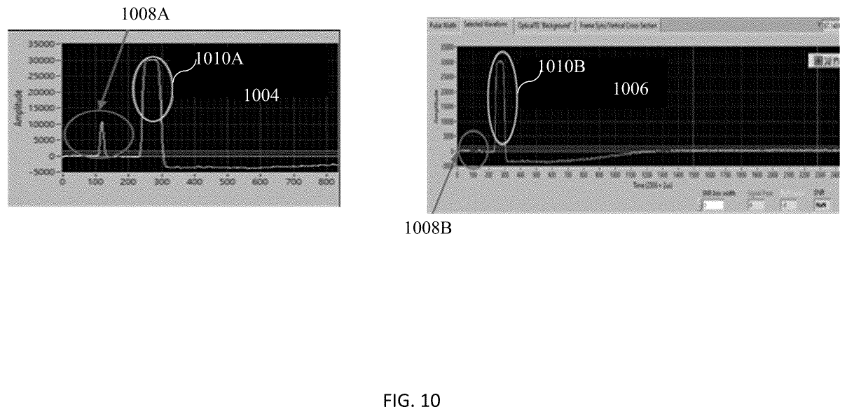

FIG. 10 illustrates an example received signal 1004 before the reference subtraction techniques are applied and the resulting output signal 1006 after the reference subtraction techniques are applied. Referring back to FIG. 8, received signal 1004 is signal X2 and the output signal 1006 is signal Z of module 800.

In the example shown in FIG. 10, the downrange object is a wall positioned 15 m away from the system. Received signal 1004 includes a first peak 1008A (i.e., Optical T0) that corresponds to the light that hits the glass window of the lidar system and then returns back to the receiver. Received signal 1004 further includes a second peak 1010A (i.e., Object) that corresponds to the light that hits the wall and then scatters off the wall and returns to the receiver. The resulting output signal 1006 after the reference subtraction techniques are applied still retains a peak 1010B that resembles peak 1010A. The first peak 1008A is almost completely removed and is replaced by an almost flat signal portion 1008B. As a result, all objects that are from 0 m to 300 m are detectable. The lidar system may measure and map any obstructions on the glass window, including water droplets, bug splatter, stickers, bird droppings, window cracks, and the like. The lidar system may also measure and map any downrange objects, including objects that are within a meter from the system or up to a few hundred meters away.

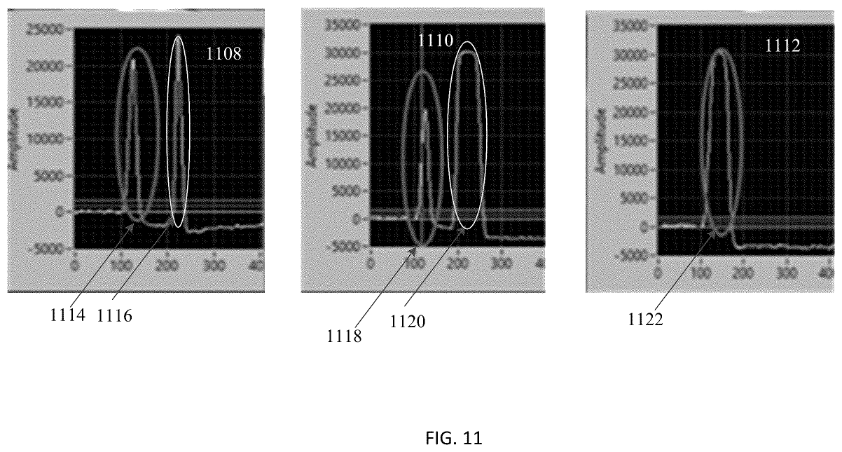

FIG. 11 illustrates examples of measuring various types of obstructions on the glass window of the lidar system. The disclosed techniques in the present application enable the mapping of an obstruction in fine detail on a per-ray basis, where the obstruction can be finely quantified and classified. With the Optical T0 removed using the Optical T0 reference subtraction techniques, objects that are directly on the surface of the window may be detected. This allows for per-ray detection and analysis of obstructions such as rain droplets, bug splatters, or a full blockage.

In setup #1, water droplets on the glass window form one type of partial window obstruction. Received signal 1108 for setup #1 includes a first peak 1114 that corresponds to the light that is scattered by the blockage caused by the water droplets on the window and then returns back to the receiver. Received signal 1108 further includes a second peak 1116 that corresponds to the light that hits a downrange object in front of the window and then scatters off the object and returns to the receiver.

In setup #2, a bug splatter on the glass window forms another type of partial window obstruction. Received signal 1110 for setup #2 includes a first peak 1118 that corresponds to the light that is scattered by the blockage caused by the bug splatter on the window and then returns back to the receiver. Received signal 1110 further includes a second peak 1120 that corresponds to the light that hits a downrange object in front of the window and then scatters off the object and returns to the receiver.

In setup #3, a tape is attached onto the glass window to form a type of full obstruction. Received signal 1112 for setup #3 includes only a single peak 1122 that corresponds to the light that is scattered by the opaque tape on the window and then returns back to the receiver. In this example, the full blockage caused by the tape on the window prevents the light from going through the window to reach any downrange objects, and as a result there is no secondary returns in received signal 1112.

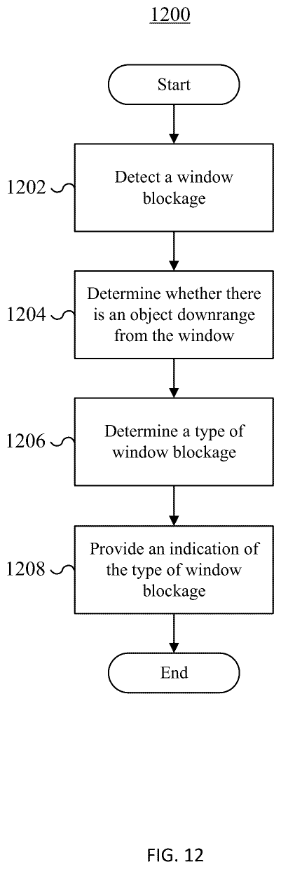

FIG. 12 illustrates an example process 1200 for detecting and classifying a type of window blockage. In some embodiments, process 1200 may be implemented or performed by receiver 140 and controller 150 of lidar system 100 of FIGS. 1-4. For example, in some embodiments, process 900 is performed at least as a part of step 705 and/or step 707 of FIG. 7. In some embodiments, different types of obstructions may be classified based on certain characteristics of the received signal after the Optical T0 return is removed using the Optical T0 reference subtraction techniques.

At step 1202, a window blockage is detected based on a detected distance associated with a first peak of a received signal and a predetermined threshold range from the window. For example, the predetermined threshold range from the window may be a range that is within a very short distance from the window. If the detected distance associated with a first peak of a received signal is below or within the predetermined threshold range, then a window blockage is detected. For example, as shown in FIG. 11, received signal 1108, received signal 1110, and received signal 1112 each include a first peak (first peak 1114, first peak 1118, and first peak 1122, respectively) that has a detected distance that is within a predetermined threshold range. Therefore, each of these peaks is detected as a window blockage.

At step 1204, it is determined whether an object downrange from the window is detected. For example, if a second peak of the received signal is detected and the detected distance associated with this second peak is above the predetermined threshold range, then it is determined that an object is downrange from the window. For example, as shown in FIG. 11, received signal 1108 and received signal 1110 each include a second peak (i.e., second peak 1116 and second peak 1120, respectively) that has a detected distance that is above the predetermined threshold range. Therefore, each of these second peaks is detected as a downrange object. However, if a second peak of the received signal is not detected, then it is determined that there is no object that is downrange from the window. For example, as shown in FIG. 11, received signal 1112 does not include a second peak because the full blockage caused by the tape on the window prevents the light to go through the window to reach any downrange objects.

At step 1206, a type of window blockage is determined. In some embodiments, different types of blockages may be classified based on certain characteristics of the received signal. In some embodiments, different degrees of blockages may be determined. For example, blockages may be classified as a full blockage, a medium degree of blockage, or a low degree of blockage.

In some embodiments, the type of blockage or the degree of blockage on the window may be in part determined based on the size, width, magnitude, power, or energy of the first peak of the received signal. For example, first peak 1122 of received signal 1112, first peak 1114 of received signal 1108, and first peak 1118 of received signal 1110 are in a descending order in terms of their respective size, width, magnitude, power, or energy, and therefore they may be classified as a full blockage, a medium degree of blockage, and a low degree of blockage, respectively. As another example, they may be classified as an opaque blockage, a blockage caused by water droplets, and a blockage caused by bug splatters, respectively.

In some embodiments, the type of blockage or the degree of blockage on the window may be in part determined based on the size, width, magnitude, power, or energy of the second peak of the received signal. For example, second peak 1120 of received signal 1110 has a greater size, width, magnitude, power, or energy than second peak 1116 of received signal 1108, whereas received signal 1112 has no second peaks detected. Therefore, these three cases may be classified as a low degree of blockage, a medium degree of block, and a full or opaque blockage, respectively.

At step 1208, an indication of the type of window blockage is provided. For example, an indication may be sent to inform the user the type or degree of window blockage detected by the system. An alert may be sent to prompt the user to clean the window, disengage autopilot until the window is cleaned, and the like.

It should be recognized that process 1200 may be performed to cover different regions of the window to create a per-ray obstruction map of the entire window. For example, the system may report that 90% of the window is clean, but 10% of the window has a certain degree of blockage. Both the locations and the sizes of the obstructions may be indicated in the obstruction map.

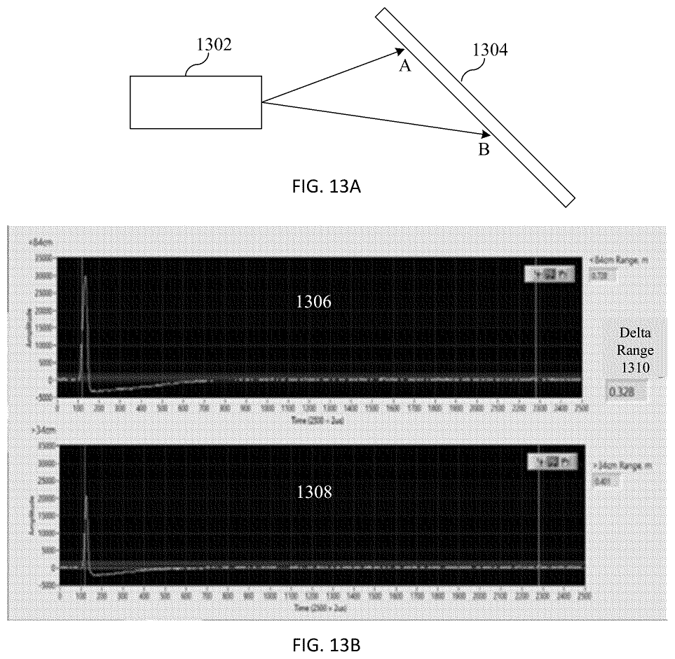

FIG. 13A illustrates a lidar system 1302 detecting a wall 1304 at two different points (A and B) on the surface. The surface of wall 1304 is tilted at an angle. FIG. 13B illustrates the received signals corresponding to the measurement at point A and the measurement at point B of wall 1304, respectively.

As shown in FIG. 13B, received signal 1306 corresponds to the measurement for point B. Received signal 1306 includes only a single peak that corresponds to the light that is scattered by wall 1304 at point B and then returns back to the receiver. Received signal 1308 corresponds to the measurement for point A. Received signal 1308 includes only a single peak that corresponds to the light that is scattered by wall 1304 at point A and then returns back to the receiver. With the Optical T0 removed using the Optical T0 reference subtraction techniques, the ranging algorithm is able to extract the sub-sample fine rate resolution, and accurately measure the distances and the tilt of the board. Undistorted return signals are detected at exactly the right locations. The delta range 1310 of point A and point B is accurately detected by the system as 0.328 m (i.e., 32.8 cm).

The Optical T0 reference subtraction techniques may also be used to remove multiple Optical T0 returns that correspond to other subsequently emitted laser pulses that hit the front window and then return to the receiver.

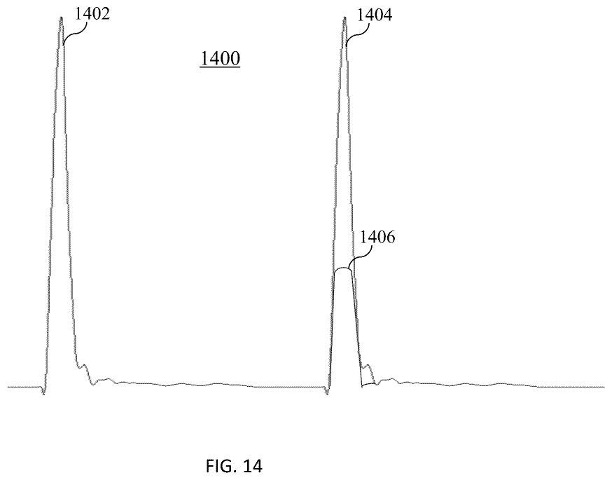

FIG. 14 illustrates an example received signal 1400 when two laser pulses are emitted consecutively. Received signal 1400 includes a first Optical T0 peak 1402 that corresponds to a first light pulse emitted at t₀ that hits the glass window of the lidar system and then returns back to the receiver. Received signal 1400 includes a second Optical T0 peak 1404 that corresponds to a second light pulse that is emitted at t₁ that hits the glass window of the lidar system and then returns back to the receiver. Part of the first light pulse travels through the window and reaches a downrange object that is located at a distance d (e.g., 170 m) from the system, scatters off this object and returns to the receiver, which appears as a small peak 1406 in received signal 1400. Since the downrange object is located far away, the magnitude of peak 1406 is much smaller compared to Optical T0 peak 1404. Therefore, the lidar system needs to remove Optical T0 peak 1404 from received signal 1400, such that the lidar system may reliably detect peak 1406 and determine the distance of the object.

In some embodiments, one or more copies of Optical T0 reference signal Y may be superimposed onto Optical T0 reference signal Y to produce a combined compensating signal Y′, with each of the one or more copies of the Optical T0 reference signal Y shifted by a corresponding time offset. Referring back to FIG. 8, the combined compensating signal Y′ may be used as an input to Optical T0 compensation module 808, such that both Optical T0 peak 1402 and Optical T0 peak 1404 may be removed. In particular, the combined compensating signal Y′ is the original Optical T0 reference signal Y combined with a copy of signal Y that is shifted by a predetermined time offset T. The predetermined time offset T is determined based on a time period between t₀ and t₁, where t₀ is the time when the first light pulse is emitted and t₁ is the time when the second light pulse is emitted.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a light source configured to emit an output beam comprising a plurality of light pulses through a window;
a receiver, wherein the receiver is configured to detect a reference signal, the reference signal corresponding to one of the plurality of light pulses reflected from the window, and wherein the receiver is configured to detect a received signal, the received signal comprising a signal portion corresponding to one of the plurality of light pulses scattered by a target located at a distance; and
a processor configured to determine the distance to the target using the received signal, including by being configured to subtract the reference signal from the received signal.

2. The system of claim 1, wherein the receiver is configured to:
detect the reference signal in response to a trigger of a reference signal extraction phase.

3. The system of claim 2, wherein the reference signal extraction phase comprises one of the following: a system initialization phase, a periodic phase over time, or a phase triggered by a temperature drift.

4. The system of claim 3, wherein the processor is configured to:
disable the reference signal extraction phase in response to detecting an object.

5. The system of claim 1, wherein the processor is configured to:
update the reference signal, comprising:
detecting an additional signal by the receiver, wherein the additional signal corresponds to another one of the plurality of light pulses reflected from the window; and
updating the reference signal at least in part based on a statistical measure of the reference signal and the additional signal.

6. The system of claim 1, wherein the receiver is configured to:
filter the reference signal including by applying a filtering window around a peak of a pulse in the reference signal, wherein a width of the filtering window is at least in part based on a width of the pulse.

7. The system of claim 1, wherein the receiver is configured to:
temporally shift the reference signal in response to a detected jitter in the received signal prior to subtracting the reference signal from the received signal.

8. The system of claim 7, wherein the processor is configured to:
align a rising edge of a peak of a pulse in the reference signal with a rising edge of a peak of a pulse in the received signal.

9. The system of claim 1, wherein the processor is further configured to:
in response to determining that the distance to the target is within a predetermined threshold range, determine that the target comprises a blockage on the window.

10. The system of claim 9, wherein the processor is further configured to:
determine a type of the blockage on the window at least in part based on one or more of the following: a size, a width, a magnitude, a power level, or an energy level of a peak in the received signal that corresponds to the blockage on the window.

11. The system of claim 10, wherein the received signal comprises a second signal portion corresponding to one of the plurality of light pulses scattered by a second target located at a second distance, the processor is configured to:
determine the second distance to the second target after the reference signal is subtracted from the received signal;
in response to determining that the second distance is above the predetermined threshold range, determine that the second target is a downrange object; and
determine the type of the blockage on the window at least in part based on one or more of the following: a size, a width, a magnitude, a power level, or an energy level of a second peak in the received signal that corresponds to the second target.

12. The system of claim 9, wherein the processor is configured to:
provide an indication of a type of the blockage on the window.

13. The system of claim 1, wherein the processor is configured to:
superimpose a copy of the reference signal shifted by a predetermined time offset to the reference signal to form a modified version of the reference signal, wherein the reference signal subtracted from the received signal is the modified version of the reference signal.

14. The system of claim 13, wherein the predetermined time offset is determined based on a time period between two of the plurality of light pulses that are consecutive to each other.

15. A method, comprising:
emitting an output beam comprising a plurality of light pulses through a window;
detecting a reference signal by a receiver, wherein the reference signal corresponds to one of the plurality of light pulses reflected from the window;
detecting a received signal by the receiver, wherein the received signal comprises a signal portion corresponding to one of the plurality of light pulses scattered by a target located at a distance; and
determining, by a processor, the distance to the target using the received signal, including by subtracting the reference signal from the received signal.

16. The method of claim 15, further comprising:
filtering the reference signal including by applying a filtering window around a peak of a pulse in the reference signal, wherein a width of the filtering window is at least in part based on a width of the pulse.

17. The method of claim 15, further comprising:
temporally shifting the reference signal in response to a detected jitter in the received signal prior to subtracting the reference signal from the received signal.

18. The method of claim 15, further comprising:
in response to determining that the distance to the target is within a predetermined threshold range, determining that the target comprises a blockage on the window.

19. The method of claim 18, further comprising:
determining a type of the blockage on the window at least in part based on one or more of the following: a size, a width, a magnitude, a power level, or an energy level of a peak in the received signal that corresponds to the blockage on the window.

20. A system, comprising:
a light source configured to emit an output beam comprising a plurality of light pulses through a window;
a receiver, wherein the receiver is configured to detect a reference signal, the reference signal corresponding to one of the plurality of light pulses reflected from the window, and wherein the receiver is configured to detect a received signal, the received signal comprising a signal portion corresponding to one of the plurality of light pulses scattered by a target located at a distance; and
a processor configured to:
determine a compensating signal by adding a copy of the reference signal that is shifted by a predetermined time offset to the reference signal; and
determine the distance to the target using the received signal, including by being configured to subtract the compensating signal from the received signal.
